(19) United States
(12) Patent Application Publication
(10) Pub. No.: US 2026/0080021 A1
(43) Pub. Date: Mar. 19, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takashi YAMADA, Tokyo (JP)

(21) Appl. No.: 19/282,859

(22) Filed: Jul. 28, 2025

(30) Foreign Application Priority Data
Sep. 17, 2024 (JP) 2024-159811

(51) Int. Cl. G06F 16/953; G06F 40/30

(52) U.S. Cl. CPC G06F 16/953; G06F 40/30

(57) ABSTRACT

An information processing apparatus according to the present application includes an estimation unit that estimates a direction of an opinion that is expressed in a predetermined content, a search unit that searches for a conflicting content that indicates a conflicting opinion that conflicts with the direction of the opinion that is estimated by the estimation unit, and a providing unit that provides the conflicting content when predetermined operation (for example, operation of flipping the predetermined content) is performed on the predetermined content.

### CROSS-REFERENCE TO RELATED APPLICATIONS

The present application claims priority to and incorporates by reference the entire contents of Japanese Patent Application No. 2024-159811 filed in Japan on Sep. 17, 2024.

### BACKGROUND OF THE INVENTION

### 1. Field of the Invention

The present invention relates to an information processing apparatus, an information processing method, and a non-transitory computer readable storage medium.

### 2. Description of the Related Art

Conventionally, a technology related to information distribution via the Internet is known. As one example of the technology as described above, a service of receiving a selection of a theme from a user when distributing a content, such as a news article, and providing a news article that is included in the selected theme, a comment on the news article, or the like is known.

However, in the technology as described above, it is not always possible for a user to easily view a content that indicates a conflicting opinion on a predetermined content.

For example, in the technology as described above, only a content that conforms to the theme selected by the user is provided, and it is not always possible for the user to easily vie a content that indicates a conflicting opinion on a predetermined content.

### SUMMARY OF THE INVENTION

It is an object of the present invention to at least partially solve the problems in the conventional technology.

An information processing apparatus according to the present application includes an estimation unit that estimates a direction of an opinion that is expressed in a predetermined content, a search unit that searches for a conflicting content that indicates a conflicting opinion that conflicts with the direction of the opinion that is estimated by the estimation unit, and a providing unit that provides the conflicting content when predetermined operation is performed on the predetermined content. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to one embodiment;

FIG. 2 is a first diagram illustrating an example of a screen of a user terminal 100;

FIG. 3 is a second diagram illustrating an example of the screen of the user terminal 100;

FIG. 4 is a diagram illustrating a configuration example of an information processing apparatus 10 according to one embodiment;

FIG. 5 is a diagram illustrating an example of a content information database 31;

FIG. 6 is a flowchart illustrating an example of the flow of the information processing according to one embodiment; and

FIG. 7 is a hardware configuration diagram illustrating an example of a computer that implements functions of the information processing apparatus 10.

### DETAILED DESCRIPTION OF THE PREFERRED EMBODIMENTS

Modes (hereinafter, referred to as “embodiments”) for carrying out an information processing apparatus, an information processing method, and a non-transitory computer readable storage medium according to the present application will be described in detail below with reference to the drawings. Meanwhile, the information processing apparatus, the information processing method, and the non-transitory computer readable storage medium according to the present application are not limited by the embodiments below. Further, in each of the embodiments described below, the same components are denoted by the same reference symbols, and repeated explanation will be omitted.

### 1. EMBODIMENT

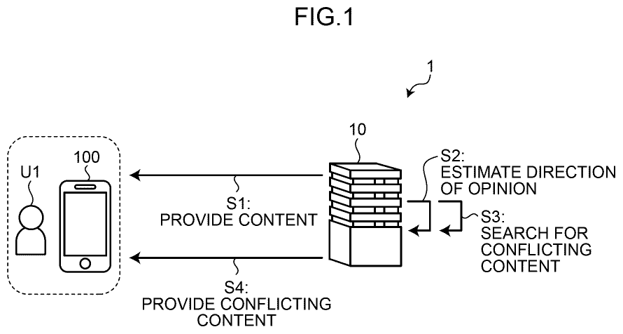

Information processing that is implemented by an information processing apparatus or the like according to one embodiment will be described below with reference to FIG. 1. FIG. 1 is a diagram illustrating an example of the information processing according to one embodiment. Meanwhile, in FIG. 1, an information processing apparatus 10 that is one example of the information processing apparatus according to the present application implements the information processing or the like according to one embodiment.

As illustrated in FIG. 1, an information processing system 1 according to one embodiment includes the information processing apparatus 10 and a user terminal 100. The information processing apparatus 10 and the user terminal 100 are communicably connected to each other in a wired or wireless manner via a network N (for example, see FIG. 4). The network N is, for example, a Wide Area Network (WAN), such as the Internet. Meanwhile, the information processing system 1 illustrated in FIG. 1 may include the plurality of information processing apparatuses 10 and the plurality of user terminals 100.

The information processing apparatus 10 illustrated in FIG. 1 is an information processing apparatus that performs information processing according to one embodiment, and is implemented by, for example, a server apparatus, a cloud system, or the like. In the example illustrated in FIG. 1, for example, the information processing apparatus 10 is an information processing apparatus that provides a news service for providing a content related to a news article to a user.

Meanwhile, the information processing apparatus 10 may have a function as a web server that provides a web site for the news service. Further, the information processing apparatus 10 may be an apparatus that distributes, to the user terminal 100, information that is displayed on an application (hereinafter, may be described as a “news application”) that is related to the news service and that is installed in the user terminal 100. Furthermore, the information processing apparatus 10 may be a server that distributes data itself of the news application. Moreover, the information processing apparatus 10 may function as a distribution apparatus that distributes control information to the user terminal 100. Here, the control information is written in, for example, a script language, such as JavaScript (registered trademark), or a style sheet language, such as Cascading Style Sheets (CSS). Meanwhile, the news application that is distributed from the information processing apparatus 10 may be regarded as the control information.

The user terminal 100 illustrated in FIG. 1 is an information processing apparatus that is used by a user. The user terminal 100 is implemented by, for example, a smartphone, a tablet terminal, a notebook Personal computer (PC), a desktop PC, a mobile phone, a Personal Digital Assistant (PDA), or the like. Meanwhile, in the example illustrated in FIG. 1, a case is illustrated in which the user terminal 100 is a smartphone that is used by the user.

Furthermore, the user terminal 100 displays, by a web browser or an application, information that is provided by the information processing apparatus 10. Meanwhile, when receiving, from the information processing apparatus 10 or the like, control information for implementing an information display process, the user terminal 100 performs the display process in accordance with the control information.

Information processing that is performed by the information processing apparatus 10 will be described below with reference to FIG. 1. Meanwhile, in the following explanation, it is assumed that the user terminal 100 is used by a certain user (a user U1) who is identified by a user ID of “UID #1”. Further, in the following explanation, the user terminal 100 may be regarded as the user U1. In other words, in the following, the user U1 may be replaced with the user terminal 100.

Furthermore, in the following explanation, it is assumed that the news application is installed in advance in the user terminal 100.

Firstly, the information processing apparatus 10 provides a content related to a news article to the user terminal 100 via the news application (Step S1). For example, the information processing apparatus 10 provides a news article #1 or a content #1 that indicates a comment group #1 that is posted with respect to the news article #1 to the user terminal 100 in accordance with operation that is performed by the user U1.

Subsequently, the information processing apparatus 10 estimates a direction of an opinion that is expressed in the content #1 (Step S2). For example, the information processing apparatus 10 estimates a direction of an opinion that is expressed in the news article #1, a direction of an opinion that is expressed in each of comments in the comment group #1, or the like by using a text mining technology. As a specific example, the information processing apparatus 10 estimates the direction of the opinion that is expressed in the news article #1 or the direction of the opinion that is expressed in each of the comments in the comment group #1 by extracting a keyword or performing a sentiment analysis in relation to the extracted keyword by using the text mining technology.

As one example, the information processing apparatus 10 extracts, as the keyword, an event #1 that is indicated by the news article #1 (in other words, an event that is reported by the news article #1), a subject that is related to the event #1, or the like. Further, the information processing apparatus 10 estimates, as the direction of the opinion that is expressed in the news article #1, whether the news article #1 is positive, negative, or neutral about the extracted keyword. Furthermore, the information processing apparatus 10 estimates, as the direction of the opinion that is expressed in each of the comments in the comment group #1, whether each of the comments is positive, negative, or neutral about the extracted keyword.

Here, the event #1 indicated by the news article #1 indicates, for example, a disaster, an accident, an incident, a scandal, or the like. Further, the subject related to the event #1 indicates, for example, a person, an organization, a building, a structure, or the like.

Meanwhile, it is possible to use an arbitrary text mining technology. Further, the information processing apparatus 10 may estimate the direction of the opinion that is expressed in the content #1 by using, for example, a model #1 that is trained to generate an answer to an input question.

As one example, the information processing apparatus 10 estimates the direction of the opinion that is expressed in the news article #1 by inputting, to the model #1, information (for example, text information) on the news article #1 and an instruction sentence for instructing to output the direction of the opinion that is expressed in the news article #1 with respect to the keyword based on the information on the news article #1. Further, the information processing apparatus 10 estimates the direction of the opinion that is expressed in each of the comments in the comment group #1 by inputting, to the model #1, information (for example, text information) on the comment that is posted with respect to the news article #1 and an instruction sentence for instructing to output the direction of the opinion on the keyword based on the information on the news article #1.

Here, the model #1 is a model that is trained to output an answer sentence to an input question sentence, and is a language model, such as a Generative Pre-trained Transformer (GPT) or a Transformer, that performs natural language processing. Further, the model #1 is prepared inside the information processing apparatus 10 and is originally generated by a business operator who manages the information processing apparatus 10. Meanwhile, it is desirable to perform training such that the input information is not used as a new answer to conceal the input information, such as personal information.

Subsequently, the information processing apparatus 10 searches for a conflicting content that conflicts with the direction of the opinion that is expressed in the content #1 (Step S3). For example, the information processing apparatus 10 searches for a news article (hereinafter, may be described as a “conflicting article”) that conflicts with the direction of the opinion that is expressed in the news article #1 from a news article group #1 that indicates the event #1. In other words, the information processing apparatus 10 searches for a conflicting article as an example of the conflicting content.

As a specific example, the information processing apparatus 10 estimates a direction of an opinion that is expressed in each of contents that are included in the news article group #1 by using the same method as described above. Further, the information processing apparatus 10 searches for, as the conflicting article, a news article that conflicts with the direction of the opinion that is expressed in the news article #1 from the news article group #1. As one example, when the news article #1 is negative about a keyword of “person #1”, the information processing apparatus 10 searches for a news article that is positive about the keyword of “person #1” from the news article group #1.

Furthermore, the information processing apparatus 10 searches for, from the comment group #1, a comment whose direction of an opinion is conflicting (hereinafter, may be described as a “conflicting comment”) for each of the comments that are included in the comment group #1. In other words, the information processing apparatus 10 searches for the conflicting comment as one example of the conflicting content.

As one example, when a comment #1 that is included in the comment group #1 is negative about the keyword of “person #1”, the information processing apparatus 10 searches for, as the conflicting comment, a comment that is positive about the keyword of “person #1” from the comment group #1.

Meanwhile, the information processing apparatus 10 may set a keyword (hereinafter, a “conflicting keyword”) for searching for the conflicting content, and search for the conflicting content by using the conflicting keyword. For example, the information processing apparatus 10 searches for the conflicting article based on the conflicting keyword that indicates an antonym of a character string that is included in the news article #1. As one example, when the news article #1 includes a character string of “the person #1 is a responsible person”, the information processing apparatus 10 searches for the conflicting article by using “the person #1 is not a responsible person” as the conflicting keyword.

Subsequently, when the user U1 performs predetermined operation on the content #1, the information processing apparatus 10 provides the conflicting content to the user terminal 100 (Step S4). For example, when receiving, from the user terminal 100, operation of flipping the news article #1, the information processing apparatus 10 provides the conflicting article that conflicts with the news article #1. Further, when receiving, from the user terminal 100, operation of flipping any of the comments in the comment group #1, the information processing apparatus 10 provides the conflicting comment that conflicts with the subject comment.

In other words, when the operation of flipping the news article or the comment is performed, the information processing apparatus 10 reverses the direction of the opinion indicated by the news article or the comment (in other words, one perspective), and provides a news article or a comment that indicates a conflicting opinion (in other words, the other perspective).

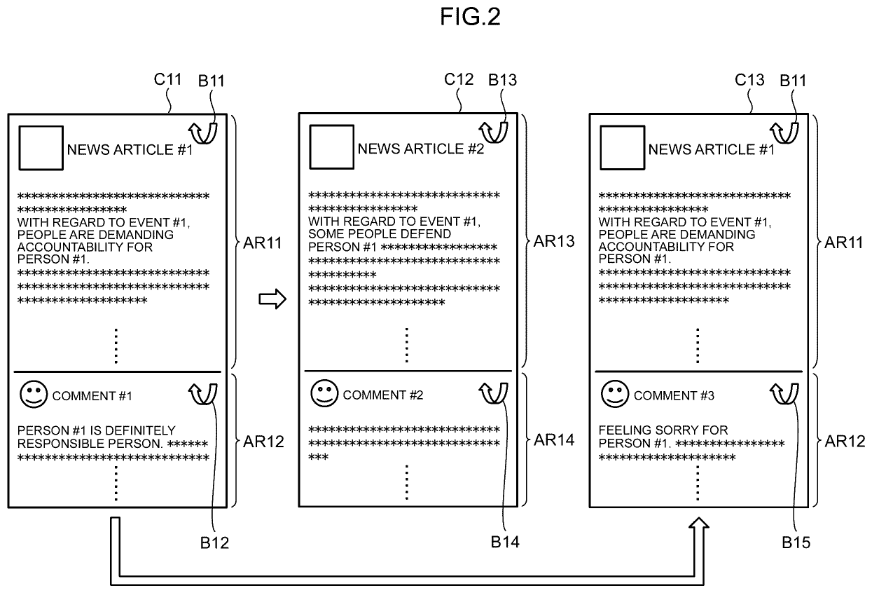

The conflicting content that is provided to the user terminal 100 will be described below with reference to FIG. 2. FIG. 2 is a first diagram illustrating an example of a screen of the user terminal 100.

As illustrated in FIG. 2, the user terminal 100 displays a screen C11 that includes the content #1. For example, the user terminal 100 displays the screen C11 that includes an area AR11 in which text information that represents the news article #1, image information, a button B11 for performing operation of flipping the news article #1, and the like are displayed, and an area AR12 in which the comment #1 that is posted with respect to the news article #1, a button B12 for performing operation of flipping the comment #1, and the like are displayed. As a specific example, the user terminal 100 displays the screen C11 that includes the news article #1 that is negative about the keyword of “person #1” and the comment #1 that is negative about the keyword of “person #1”.

Here, when the user U1 presses the button B11 in the screen C11, the user terminal 100 displays a screen C12 that includes a news article #2 that conflicts with the direction of the opinion that is expressed in the news article #1. For example, the user terminal 100 displays the screen C12 that includes an area AR13 in which text information that represents the news article #2, image information, a button B13 for performing operation of flipping the news article #2, and the like are displayed, and an area AR14 in which a comment #2 that is posted with respect to the news article #2, a button B14 for performing operation of flipping the comment #2, and the like are displayed. As a specific example, the user terminal 100 displays the screen C12 that includes the news article #2 that is positive about the keyword of “person #1”.

Furthermore, when the user U1 presses the button B12 in the screen C11, a screen C13 that includes a comment #3 that conflicts with the direction of the opinion indicated by the comment #1 is displayed from among the comments that are included in the comment group #1. For example, the user terminal 100 displays the comment #3 in the area AR12 in place of the comment #1. As a specific example, the user terminal 100 displays the comment #3 that is positive about the keyword of “person #1”. Moreover, the user terminal 100 displays a button B15 for performing operation of flipping the comment #3 in the area AR12.

Meanwhile, the flipping operation is not limited to pressing of the button, but may be arbitrary operation. For example, the flipping operation may be drag operation, swipe operation, operation of shaking the user terminal 100, or the like.

As described above, the information processing apparatus 10 according to one embodiment provides the conflicting article or the conflicting comment in accordance with the operation of flipping the news article or the comment. With this configuration, the information processing apparatus 10 according to one embodiment is able to allow the user to easily view a content that indicates an opinion on a predetermined content.

Furthermore, in the news service or the like, in some cases, a content that is personalized for the user is preferentially provided, and, as a result, a direction of an opinion of the provided content may be biased.

Moreover, in some cases, the user wants to view a content with a different perspective from the provided content; however, in this case, operation of searching for the content with the different perspective from among provided contents that are personalized may be a burden on the user. To cope with this, the information processing apparatus 10 according to one embodiment allows the user to easily view the content that indicates a conflicting opinion on a content that has been provided to the user, so that it is possible to improve usability in the news service.

### 2. EXAMPLES OF OTHER PROCESSES

Meanwhile, the processes as described above are examples, and the information processing apparatus 10 may perform various kinds of processes by using various kinds of information. Examples of other processes will be described below.

### 2-1. Process Corresponding to Highlighted Display of Content

In the example illustrated in FIG. 1, the information processing apparatus 10 may estimate a direction of an opinion that is expressed in a certain part that is displayed in a highlighted manner (highlight) by the user U1 in the content #1, and when operation of flipping the certain part is performed, the information processing apparatus 10 may provide a conflicting content that conflicts with the direction of the opinion that is expressed in the certain part.

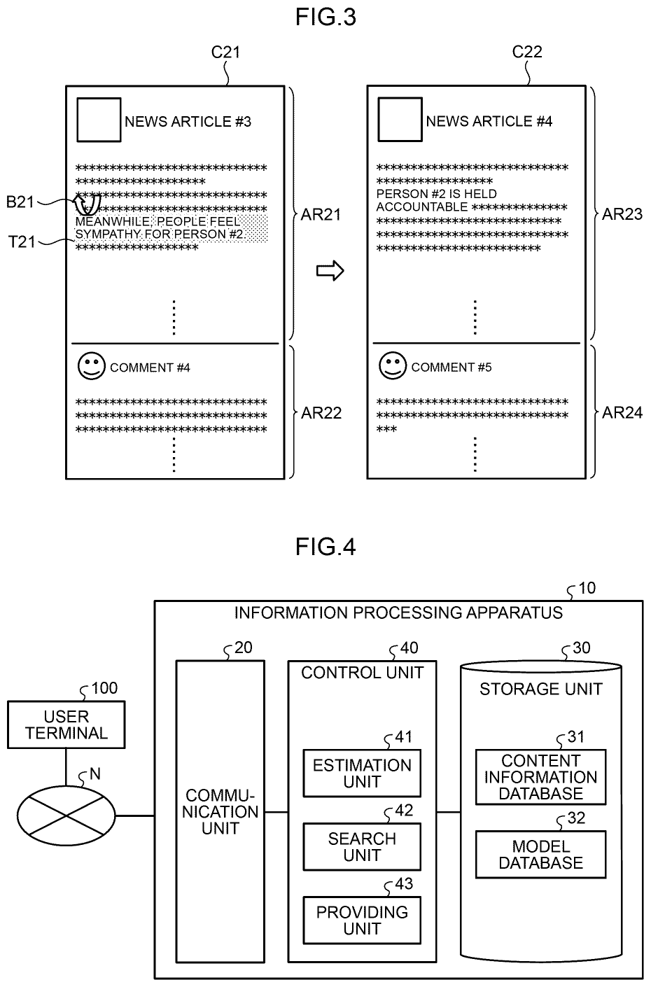

The conflicting content that is provided to the user terminal 100 will be described below with reference to FIG. 3. FIG. 3 is a second diagram illustrating an example of the screen of the user terminal 100.

As illustrated in FIG. 3, the user terminal 100 displays a screen C21 that includes a content related to a news article #3. For example, the user terminal 100 displays the screen C21 that includes an area AR21 in which text information that represents the news article #3, image information, and the like are displayed, and an area AR22 in which a comment #4 that is posted with respect to the news article #3 is displayed.

Here, it is assumed that the user U1 performs operation of displaying a character string T21 in a highlighted manner in the text information that represents the news article #3. In this case, the user terminal 100 displays, on the character string T21, a button B21 for performing operation of flipping the character string T21. Further, when the user U1 presses the button B21, the user terminal 100 displays a screen C22 that includes a news article #4 that conflicts with a direction of an opinion that is expressed by the character string T21. For example, the user terminal 100 displays the screen C22 that includes an area AR23 in which text information that represents the news article #4, image information, and the like are displayed, and an area AR24 in which a comment #5 that is posted with respect to the news article #4 is displayed.

As one example, when the character string T21 represents an opinion that is positive about a keyword of “person #2”, the user terminal 100 displays the screen C22 that includes the news article #4 that is negative about the keyword of “person #2”.

### 2-2. Provision of Related Content

In the example illustrated in FIG. 1, the information processing apparatus 10 may search for a related content that is different from the conflicting content based on the direction of the opinion that is expressed in the content #1, and, when operation (hereinafter, may be described as “related operation”) that is different from the flipping operation is performed on the content #1, the information processing apparatus 10 may provide the related content. Meanwhile, the related operation may be, for example, arbitrary operation, such as pressing of a predetermined button, drag operation, swipe operation, or operation of shaking the user terminal 100, as long as the operation is different from the flipping operation.

### 2-2-1. Provision of Corresponding Content

The information processing apparatus 10 may provide a corresponding content that corresponds to the direction of the opinion that is expressed in the content #1. For example, the information processing apparatus 10 searches for, from the news article group #1, a news article (hereinafter, may be described as a “corresponding article”) that represents an opinion that corresponds to the direction of the opinion that is expressed in the news article #1. Further, when the related operation is performed on the news article #1, the information processing apparatus 10 provides the corresponding article. As one example, when the news article #1 is negative about the keyword of “person #1”, the information processing apparatus 10 provides a news article that is negative about the keyword of “person #1” as the corresponding article.

Furthermore, the information processing apparatus 10 searches for, from the comment group #1, a comment (hereinafter, may be described as a “corresponding comment”) that corresponds to the direction of the opinion for each of the comments that are included in the comment group #1. Moreover, when the related operation is performed on the comment #1, the information processing apparatus 10 provides the corresponding comment. As one example, when the comment #1 is negative about the keyword of “person #1”, the information processing apparatus 10 provides a comment that is negative about the keyword of “person #1” as the corresponding comment.

### 2-2-2. Provision of Different Opinion Content

The information processing apparatus 10 may provide a different opinion content that is different from the direction of the opinion that is expressed in the content #1 and that represents a different opinion from the conflicting opinion. For example, the information processing apparatus 10 searches for, from the news article group #1, a news article (hereinafter, may be described as a “different opinion article”) that is different from the direction of the opinion that is expressed in the news article #1 and that represents a different opinion from the conflicting opinion. Further, when the related operation is performed on the news article #1, the information processing apparatus 10 provides the different opinion article. As one example, when the news article #1 is negative about the keyword of “person #1”, the information processing apparatus 10 provides a news article that is neutral about the keyword of “person #1” as the different opinion article.

Furthermore, the information processing apparatus 10 searches for, from the comment group #1, a comment (hereinafter, described as a “different opinion comment) that is different from the direction of the opinion and that indicates a different opinion from the conflicting opinion, for each of the comments that are included in the comment group #1. Moreover, when the related operation is performed on the comment #1, the information processing apparatus 10 provides the different opinion comment. As one example, when the comment #1 is negative about the keyword of “person #1”, the information processing apparatus 10 provides a comment that is neutral about the keyword of “person #1” as the different opinion comment.

### 2-3. Provision of Event Content

In the example illustrated in FIG. 1, the information processing apparatus 10 may search for an event content that is a complementary content with respect to the event #1 that is indicated by the content #1, and when operation (hereinafter, may be described as “event operation”) that is different from the flip operation is performed on the content #1, the information processing apparatus 10 may provide the event content. For example, when information on the event #1 is updated with the news article #1, the information processing apparatus 10 searches for a news article (hereinafter, may be described as an “event article”) that represents the event #1 among news articles that have been distributed in the past in the news service. Further, the information processing apparatus 10 provides information indicating that the information on the event #1 is updated and provides the content #1. Here, when the event operation is performed on the content #1, the information processing apparatus 10 provides a content that represents the event article.

Meanwhile, the event operation may be, for example, arbitrary operation, such as pressing of a predetermined button, drag operation, swipe operation, or operation of shaking the user terminal 100, as long as the operation is different from the flipping operation.

### 3. CONFIGURATION OF INFORMATION PROCESSING APPARATUS

A configuration of the information processing apparatus 10 will be described below with reference to FIG. 4. FIG. 4 is a diagram illustrating a configuration example of the information processing apparatus 10 according to one embodiment. As illustrated in FIG. 4, the information processing apparatus 10 includes a communication unit 20, a storage unit 30, and a control unit 40.

### Communication Unit 20

The communication unit 20 is implemented by, for example, a Network Interface Card (NIC), or the like. Further, the communication unit 20 is connected to the network N in a wired or wireless manner and transmits and receives information to and from the user terminal 100 or the like.

### Storage Unit 30

The storage unit 30 is implemented by, for example, a semiconductor memory device, such as a Random Access Memory (RAM) or a Flash Memory, or a storage device, such as a hard disk or an optical disk. As illustrated in FIG. 4, the storage unit 30 includes a content information database 31 and a model database 32.

### Content Information Database 31

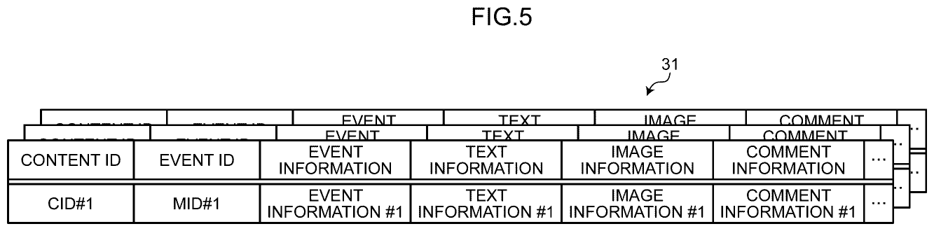

The content information database 31 stores therein various kinds of information on a content related to a news article that is provided by the news service. An example of the information that is stored in the content information database 31 will be described below with reference to FIG. 5. FIG. 5 is a diagram illustrating an example of the content information database 31. In the example illustrated in FIG. 5, the content information database 31 includes items such as a “content ID”, an “event ID”, “event information”, “text information”, “image information”, and “comment information”.

The “content ID” indicates identification information for identifying a content. The “event ID” indicates identification information for identifying an event that is indicated by a news article. The “event information” indicates information related to the event that is indicated by the news article, and stores therein, for example, information, such as an event type, an event name, or an event occurrence location. The “text information” indicates text information that is included in the news article. The “image information” indicates an image that is included in the news article. The “comment information” indicates a comment that is posted with respect to the news article.

Specifically, FIG. 5 illustrates an example in which an event that is indicated by a news article with a content that is identified by a content ID of “CID #1” is identified by an event ID of “MID #1”, event information on the event is “event information #1”, text information on the news article is “text information #1”, image information is “image information #1”, and a posted comment is a “posted comment #1”.

### Model Database 32

The model database 32 stores therein a model that is trained to generate an answer to an input question.

### Control Unit 40

The control unit 40 is a controller and implemented by, for example, causing a Central Processing Unit (CPU), a Micro Processing Unit (MPU), or the like to execute various kinds of programs that are stored in a storage device inside the information processing apparatus 10 by using a RAM as a work area. Further, the control unit 40 is a controller and implemented by, for example, an integrated circuit, such as an Application Specific Integrated Circuit (ASIC) or a Field Programmable Gate Array (FPGA). The control unit 40 according to one embodiment includes, as illustrated in FIG. 4, an estimation unit 41, a search unit 42, and a providing unit 43, and implements or performs functions or operation of information processing as described below.

### Estimation Unit 41

The estimation unit 41 estimates a direction of an opinion that is expressed in a predetermined content. For example, in the example illustrated in FIG. 1, the estimation unit 41 refers to the storage unit 30 (for example, the content information database 31) and estimates the direction of the opinion that is expressed in the content #1.

Furthermore, the estimation unit 41 may estimate a direction of an opinion that is expressed in a certain part that is designated by a user in a predetermined content. For example, in the example illustrated in FIG. 1, the estimation unit 41 estimates a direction of an opinion that is expressed in a certain part that is displayed in a highlighted manner by the user U in a content related to the news article #3, and, when operation of flipping the certain part is performed, the estimation unit 41 provides the conflicting content that conflicts with the direction of the opinion that is expressed in the certain part.

### Search Unit 42

The search unit 42 searches for a conflicting content that indicates a conflicting opinion that conflicts with the direction of the opinion that is estimated by the estimation unit 41. For example, in the example illustrated in FIG. 1, the search unit 42 searches for a conflicting content that conflicts with the direction of the opinion that is expressed in the content #1.

Furthermore, the search unit 42 may search for a conflicting content that includes a keyword that indicates a conflicting opinion. For example, in the example illustrated in FIG. 1, the search unit 42 searches for the conflicting article based on the conflicting keyword that indicates an antonym of a character string that is included in the news article #1.

Moreover, the search unit 42 may search for a related content that is different from the conflict content based on the direction of the opinion. For example, in the example illustrated in FIG. 1, the search unit 42 searches for a related content that is different from the conflict content based on the direction of the opinion that is expressed in the content #1.

Furthermore, the search unit 42 may search for a related content that indicates an opinion corresponding to the direction of the opinion. For example, in the example illustrated in FIG. 1, the search unit 42 searches for a news article that indicates an opinion that conflicts with the direction of the opinion that is expressed in the news article #1 from the news article group #1.

Moreover, the search unit 42 may search for a related content that indicates an opinion that is different from the direction of the opinion. For example, in the example illustrated in FIG. 1, the search unit 42 searches for a news article that indicates a different opinion from the direction of the opinion that is expressed in the news article #1 and that is different from the conflicting opinion from the news article group #1.

Furthermore, the search unit 42 may additionally search for an event content related to an event that is indicated by a predetermined content. For example, in the example illustrated in FIG. 1, the search unit 42 searches for an event content that is a complementary content with respect to the event #1 that is indicated by the content #1.

### Providing Unit 43

The providing unit 43 provides a conflicting content when predetermined operation is performed on a predetermined content. For example, in the example illustrated in FIG. 1, when the user U1 performs predetermined operation on the content #1, the providing unit 43 provides a conflicting content to the user terminal 100.

Furthermore, the providing unit 43 may provide a conflicting content when predetermined operation is performed on a certain part. For example, in the example illustrated in FIG. 1, when the user U1 performs predetermined operation on a certain part that is displayed in a highlighted manner, the providing unit 43 provides a conflicting content that conflicts with a direction of an opinion that is expressed in the certain part.

Moreover, the providing unit 43 may provide the conflicting content when operation of flipping a predetermined content is performed, as the predetermined operation, while the predetermined content is being viewed. For example, in the example illustrated in FIG. 1, when receiving, from the user terminal 100, information indicating that the operation of flipping the news article #1 is performed, the providing unit 43 provides the conflicting article that conflicts with the news article #1. Furthermore, when receiving, from the user terminal 100, information indicating that the operation of flipping any of the comments in the comment group #1 is performed, the providing unit 43 provides the conflicting comment that conflicts with the subject comment.

Moreover, the providing unit 43 may provide a related content when different operation from a predetermined operation is performed on a predetermined content. For example, in the example illustrated in FIG. 1, the providing unit 43 provides the related content when operation that is different from the flipping operation is performed.

Furthermore, the providing unit 43 may provide an event content when different operation from the predetermined operation is performed on the predetermined content. For example, in the example illustrated in FIG. 1, the providing unit 43 provides the event content when operation that is different from the flipping operation is performed on the content #1.

### 4. FLOW OF INFORMATION PROCESSING

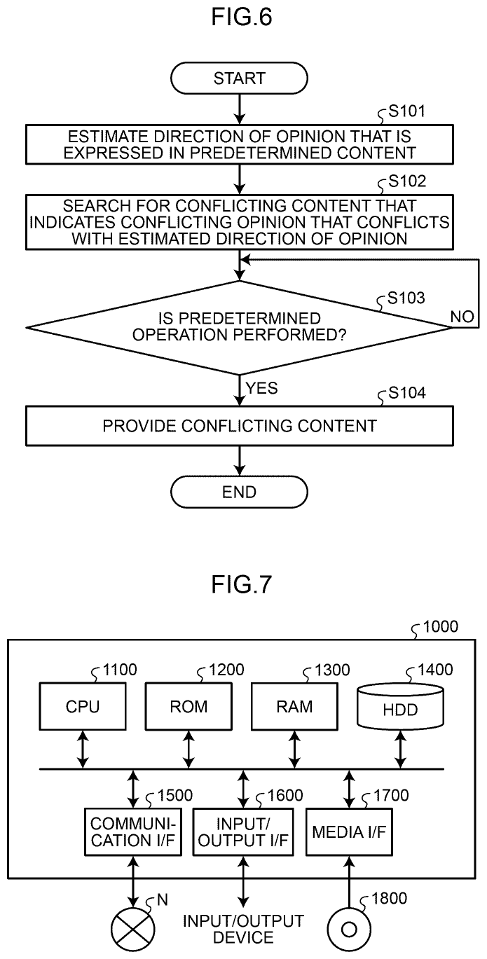

A flow of information processing performed by the information processing apparatus 10 according to one embodiment will be described below with reference to FIG. 6. FIG. 6 is a flowchart illustrating an example of the flow of the information processing according to one embodiment.

As illustrated in FIG. 6, the information processing apparatus 10 estimates a direction of an opinion that is expressed in a predetermined content (Step S101).

Subsequently, the information processing apparatus 10 searches for a conflicting content that indicates a conflicting opinion that conflicts with the estimated direction of the opinion (Step S102). Then, the information processing apparatus 10 determines whether or not predetermined operation is performed (Step S103). When the predetermined operation is not performed (Step S103; No), the information processing apparatus 10 may wait until the predetermined operation is performed.

In contrast, when the predetermined operation is performed (Step S103; Yes), the information processing apparatus 10 provides the conflicting content (Step S104), and terminates the process.

### 5. MODIFICATION

The embodiments as described above are examples, and various changes and practical applications may be made.

### 5-1. Mode of Processes

Of the processes described in the embodiments above, all or part of a process described as being performed automatically may also be performed manually.

Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments as described above may be appropriately combined as long as processing contents do not conflict with each other.

### 6. EFFECTS

As described above, the information processing apparatus 10 according to one embodiment includes the estimation unit 41, the search unit 42, and the providing unit 43. The estimation unit 41 estimates a direction of an opinion that is expressed in a predetermined content. The search unit 42 searches for a conflicting content that indicates a conflicting opinion that conflicts with the direction of the opinion that is estimated by the estimation unit 41. Further, the search unit 42 searches for a conflicting content that includes a keyword that indicates the conflicting opinion. The providing unit 43 provides the conflicting content when predetermined operation is performed on the predetermined content.

Furthermore, the providing unit 43 provides the conflicting content when operation of flipping the predetermined content is performed, as the predetermined operation, while the predetermined content is being viewed.

With this configuration, the information processing apparatus 10 according to one embodiment is able to provide the conflicting content in accordance with the operation of flipping the content, so that it is possible to allow a user to easily view a content that indicates the conflicting opinion on the predetermined content.

Furthermore, in the information processing apparatus 10 according to one embodiment, for example, the search unit 42 further searches a related content that is different form the conflicting content based on the direction of the opinion. Moreover, the providing unit 43 provides the related content when different operation from the predetermined operation is performed on the predetermined content. Furthermore, the search unit 42 searches for the related content that indicates an opinion corresponding to the direction of the opinion. Moreover, the search unit 42 searches for the related content that indicates an opinion that is different from the direction of the opinion. Furthermore, the search unit 42 further searches for an event content related to an event that is indicated by the predetermined content. Moreover, the providing unit 43 provides the event content when different operation from the predetermined operation is performed on the predetermined content.

With this configuration, the information processing apparatus 10 according to one embodiment is able to provide various kinds of contents in accordance with operation performed by the user, so that it is possible to improve usability.

Furthermore, in the information processing apparatus 10 according to one embodiment, for example, the estimation unit 41 estimates a direction of an opinion that is expressed in a certain part that is designated by the user in the predetermined content. Moreover, the providing unit 43 provides the conflicting content when the predetermined operation is performed on the certain part.

With this configuration, the information processing apparatus 10 according to one embodiment is able to provide the conflicting content with respect to the part designated by the user, so that it is possible to improve usability.

### 7. HARDWARE CONFIGURATION

The information processing apparatus 10 according to each of the embodiments as described above is implemented by, for example, a computer 1000 that is configured as illustrated in FIG. 7. In the following, explanation will be given by using the information processing apparatus 10 as an example. FIG. 7 is a hardware configuration diagram illustrating an example of a computer that implements the functions of the information processing apparatus 10. The computer 1000 includes a CPU 1100, a ROM 1200, a RAM 1300, an HDD 1400, a communication interface (I/F) 1500, an input/output interface (I/F) 1600, and a media interface (I/F) 1700.

The CPU 1100 operates based on a program that is stored in the ROM 1200 or the HDD 1400, and controls each of the units. The ROM 1200 stores therein a boot program that is executed by the CPU 1100 at the time of activation of the computer 1000, a program that is dependent on hardware of the computer 1000, and the like.

The HDD 1400 stores therein a program that is executed by the CPU 1100, data that is used by the program, and the like. The communication interface 1500 receives data from a different apparatus via a communication network 500 (corresponding to the network N of one embodiment), sends the data to the CPU 1100, and transmits data that is generated by the CPU 1100 to a different apparatus via the communication network 500.

The CPU 1100 controls an output device, such as a display and a printer, and an input device, such as a keyboard or a mouse, via the input/output interface 1600. The CPU 1100 acquires data from the input device via the input/output interface 1600. Further, the CPU 1100 outputs generated data to the output device via the input/output interface 1600.

The media interface 1700 reads a program or data that is stored in a recording medium 1800, and provides the program or the data to the CPU 1100 via the RAM 1300. The CPU 1100 loads the program from the recording medium 1800 onto the RAM 1300 via the media interface 1700, and executes the loaded program. The recording medium 1800 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 1000 functions as the information processing apparatus 10, the CPU 1100 of the computer 1000 executes a program that is loaded on the RAM 1300 and implements the functions of the control unit 40. Further, the HDD 1400 stores therein each piece of data in the storage device of the information processing apparatus 10. The CPU 1100 of the computer 1000 reads the programs from the recording medium 1800 and executes the programs; however, as another example, it may be possible to acquire the programs from a different apparatus via a predetermined communication network.

### 8. OTHERS

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

Furthermore, the information processing apparatus 10 as described above may be implemented by calling an external platform or the like for some of the functions via an Application Programming Interface (API), network computing, or the like, and the configuration may be flexibly changed.

Moreover, the “unit” described in the appended claims may be replaced with a “means”, a “circuit”, or the like. For example, the receiving unit may be replaced with a receiving means or a receiving circuit.

According to one aspect of the embodiments, it is possible to allow a user to easily view a content that indicates a conflicting opinion on a predetermined content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an estimation unit that estimates a direction of an opinion that is expressed in a predetermined content;
a search unit that searches for a conflicting content that indicates a conflicting opinion that conflicts with the direction of the opinion that is estimated by the estimation unit; and
a providing unit that provides the conflicting content when predetermined operation is performed on the predetermined content.

2. The information processing apparatus according to claim 1, wherein the search unit searches for the conflicting content that includes a keyword that indicates the conflicting opinion.

3. The information processing apparatus according to claim 1, wherein
the estimation unit estimates the direction of the opinion that is expressed in a part that is designated by a user in the predetermined content, and
the providing unit provides the conflicting content when the predetermined operation is performed on the part.

4. The information processing apparatus according to claim 1, wherein the providing unit provides the conflicting content when operation of flipping the predetermined content is performed, as the predetermined operation, while the predetermined content is being viewed.

5. The information processing apparatus according to claim 1, wherein
the search unit further searches for a related content that is different from the conflicting content based on the direction of the opinion, and
the providing unit provides the related content when different operation from the predetermined operation is performed on the predetermined content.

6. The information processing apparatus according to claim 5, wherein the search unit searches for the related content that indicates an opinion corresponding to the direction of the opinion.

7. The information processing apparatus according to claim 5, wherein the search unit searches for the related content that indicates an opinion that is different from the direction of the opinion.

8. The information processing apparatus according to claim 1, wherein
the search unit further searches for an event content related to an event that is indicated by the predetermined content, and
the providing unit provides the event content when different operation from the predetermined operation is performed on the predetermined content.

9. An information processing method implemented by a computer, the information processing method comprising:
estimating a direction of an opinion that is expressed in a predetermined content;
searching for a conflicting content that indicates a conflicting opinion that conflicts with the direction of the opinion that is estimated at the estimating; and
providing the conflicting content when predetermined operation is performed on the predetermined content.

10. A non-transitory computer readable storage medium having stored therein an information processing program that causes a computer to execute a process, the process comprising:
estimating a direction of an opinion that is expressed in a predetermined content;
searching for a conflicting content that indicates a conflicting opinion that conflicts with the direction of the opinion that is estimated at the estimating; and
providing the conflicting content when predetermined operation is performed on the predetermined content.
